(19) United States
(12) Patent Application Publication
(10) Pub. No.: US 2026/0358221 A1
(43) Pub. Date: Nov. 12, 2026

(54) Rotational Rheometer for Sequentially Analyzing Single Samples and Method for Sequentially Analyzing Single Samples in a Rotational Rheometer

(71) Applicant: Netzsch-Gerätebau, Selb (DE)

(72) Inventors: Sabrina Küspert, Selb (DE); Florian Rummel, Selb (DE); Levente Szántó, Hof (DE); Rebekka Taubmann, Selb (DE); Johannes Dunkel, Rehau (DE)

(21) Appl. No.: 19/649,377

(22) Filed: Apr. 16, 2026

(30) Foreign Application Priority Data
May 6, 2025 (DE) 10 2025 117 325.7

(51) Int. Cl. G01N 11/14

(52) U.S. Cl. CPC G01N 11/14

(57) ABSTRACT

A rotational rheometer for sequentially analyzing single samples in sample vessels of at least one sample carrier, which in each case has several sample vessels, including at least one measuring unit with a measuring head, which can be arranged on a rotatable measuring shaft and which can be sunk into the respective sample vessel, in order to form a measuring gap in the region of a sample bottom of the sample vessel; and a bearing surface for the sample carrier, which is spaced apart relative to the measuring unit, wherein at least one positioning device is provided for the flush alignment of the measuring head and of the respective sample vessel prior to the analysis of the single sample, a method for sequentially analyzing single samples in a rotational rheometer as well as a sample carrier for use in a rotational rheometer.

### TECHNICAL FIELD

The present invention relates to a rotational rheometer for sequentially analyzing single samples, a method for sequentially analyzing single samples in such a rotational rheometer as well as a sample carrier.

### BACKGROUND

Rotational rheometers serve the purpose of determining the rheological properties of material samples and hereby in particular of measuring the flow and deformation behavior under controlled shear or deformation conditions. A rotational rheometer typically comprises a rotating unit, which performs precise movements via a motor drive system in a measuring system, which has geometric elements, which make it possible to exert shear and tensile stresses on the material as well as vertical drives for setting the width of a measuring gap or for performing rheological measurements, for example as part of squeeze flow and tack test applications. Controlled shear or deformation forces are generated during the rheological analysis in order to examine flow and deformation properties of the sample material. By applying a torque and measuring the flow behavior resulting therefrom, the viscosity and the elastic behavior of the sample material can be determined. Rotational rheometers allow for the analysis of viscosity curves, shear stresses and moduli of materials under different conditions, such as, e.g., temperature, shear speed and mechanical loads, in particular deformation. Rotational rheometers are used, for example, for analyzing polymers in order to analyze the processability and the flow behavior of melts and solutions. In the food technology, consistency and texture of products can be evaluated on the basis of the rotationally rheometric analysis results, while for instance the stability and the deformation behavior of creams and ointments can be analyzed in the cosmetics and pharmaceutical industry. A measurement using a single sample usually takes place in conventional rotational rheometers, whereby a removal of the measured sample and the reloading of the rheometer with the sample to be measured subsequently is carried out by hand after performing an analysis. This turns out to be time-consuming and labor-intensive, both in the analysis preparation and post-processing and limits the sample throughput per time unit. Large sample volumes are additionally required for conventional rotationally rheometric analyses. Both has proven to be disadvantageous in particular in biomedical research and development of pharmaceutics because small sample volumes are to hereby generally be characterized simultaneously, if possible, in the interest of the reproducibility of the measurements and of a high sample throughput.

### SUMMARY

It is thus the object of the present invention to create possibilities for performing rheological analyses with a high sample throughput and/or in small sample volumes.

According to the invention, this object is in each case solved by means of the subject matters of the independent claims.

According to a first aspect of the invention, a rotational rheometer for sequentially analyzing single samples in sample vessels of at least one sample carrier, which in each case has several sample vessels, is provided, wherein the rotational rheometer comprises at least one measuring unit with a measuring head, which can be arranged on a rotatable measuring shaft and which can be sunk into the respective sample vessel, in order to form a measuring gap in the region of a sample bottom of the sample vessel, and a bearing surface for the sample carrier, which is spaced apart relative to the measuring head, wherein at least one positioning device is provided for the flush alignment of the measuring head and of the respective sample vessel prior to the analysis of the single sample.

According to a second aspect of the invention, a method for sequentially analyzing single samples in a rotational rheometer, in particular in a rotational rheometer according to the invention, is provided, which comprises the steps of: arranging one or several sample vessels, for example microtiter plates with standard formats, such as conventional so-called 96 well plates, with sample carriers having single samples placed in the sample vessels or in a bearing surface, flush alignment of the measuring head relative to a first one of the respective sample vessels by the positioning device, sinking the measuring head into the sample vessel in order to form a measuring gap between the measuring head and a vessel bottom of the sample vessel, performing the rheological measurement and analysis in the respective sample vessel and capturing rheological analysis data of each single sample by means of the sensor assembly, lifting the measuring head out of the sample vessel after conclusion of the analysis, cleaning or, in particular in the case of critical samples, replacing the measuring head or elements of the measuring head contacting the sample and repeating the preceding steps until the end of the analysis of all single samples of the sample carrier.

According to a third aspect of the invention, a sample carrier is provided, in particular for use in a rotational rheometer according to the invention, which has a plurality of sample vessels, which are arranged in a defined pattern, for a respective single sample.

According to a fourth aspect of the invention, a use of a sample carrier for sequentially rheologically analyzing single samples in a rotational rheometer, in particular in a rotational rheometer according to the invention, is provided.

An idea, on which the present invention is based, lies in performing the measurement of one or several rheological variables, such as, for example, (shear) viscosity, elongational viscosity, shear stress, viscoelastic properties, storage module and/or loss module for a plurality of samples in one analysis cycle. For this purpose, several single samples are provided in a sample carrier and each single sample is set into a horizontal and/or vertical oscillation/vibration and/or rotation by means of the measuring body. Advantageously, the invention allows for the performance of sequential measurements of a plurality of samples in one measuring cycles, in particular also with overlapping movements, without requiring manual intermediate steps, which interrupt the measuring process, for reloading the measuring device after removal of the analyzed single sample. In order to meet in particular the requirements of, for example, biomedical research and development of pharmaceuticals, a plurality of samples can advantageously be analyzed and rheologically characterized in a short time and under essentially identical conditions in the measuring environment. In instruments according to the invention with a single measuring unit, the single samples are automatically analyzed one by one, wherein an alignment of the measuring unit relative to the single sample or the sample vessel containing said single sample, respectively, takes place in each case before the respective measurement is performed after sinking the measuring head into the sample. The measuring unit thereby provides the rotating unit, wherein the measuring head, which is sunk into the sample vessel, exerts shear and tensile stresses on the single sample inside the respective sample vessel. The sink-in depth is defined on the basis of the respective sample vessel thereby, so that it is ensured that a measuring gap forms between the measuring head and the bottom of the sample vessel, in which measuring gap the flow and deformation properties of the sample material are examined. In order to simultaneously measure two or more single samples, the rotational rheometer according to the invention can be equipped with two or more identically formed measuring units, the measuring heads of which are simultaneously sunk into correspondingly spaced apart sample vessels for the measurement. The relative alignment of sample vessels and measuring units to one another takes place via the poisoning device thereby. In addition to stationary embodiments, a portable setup, for example with compressed gas cylinders for supplying an air bearing of the measuring unit and photovoltaic cells for the power supply is also possible, wherein the rotational rheometer according to the invention in the mobile design is also suitable for the use in regions or environments without sufficient infrastructure.

Advantageous embodiments and further developments follow from the subclaims, which are dependent on the independent claims, as well as from the description with reference to the figures.

According to one embodiment of the rotational rheometer, at least one positioning device is provided in the bearing surface, wherein the positioning device is configured for positioning the sample carrier in the horizontal and vertical direction relative to the measuring head. It is advantageously possible hereby to displace and to align the bearing surface and the sample carrier positioned there in the horizontal (x and y) as well as in the vertical direction (z) relative to the measuring head. A precise alignment of the sample or of the sample vessel, respectively, to the measuring unit is thus made possible in all spatial directions. The alignment can be made automatically thereby and as a function of the respective measuring program. It goes without saying that there is also the possibility of a manual alignment via corresponding control elements, for example in an instrument control software. The geometries of a plurality of sample carriers can, for this purpose, be stored in the control software so as to be capable of being selected. The arrangement and allocation of the sample vessels can be captured via the measuring software or by means of sensors correspondingly provided on the measuring unit.

According to a further development, at least one positioning device assigned to the measuring unit for positioning the measuring head, at least in the horizontal and vertical direction relative to the sample carrier, is provided in the rotational rheometer according to the invention. The positioning of the measuring unit – and thus of the measuring head – in the horizontal (x and y) as well as vertical direction (z) relative to a sample carrier, which is arranged in a fixed position, makes this possible in an advantageous manner. In this embodiment, only the measuring unit, instead of the sample carrier, is thus moved and is aligned relative to the stationary sample carrier or the sample vessels provided there, respectively. A positioning device in or on the bearing surface can thus be forgone. A further advantage of this embodiment lies in the possibility of optionally pivoting or of tiling the measuring unit by means of the correspondingly designed positioning device, so that the measuring head is able to perform shears in all spatial directions inside the sample vessel. This allows for a comprehensive analysis of the rheological behavior of the sample and provides for the capture of complex deformation properties.

It goes without saying that a combination of the two above-described embodiments is also possible, wherein the measuring unit as well as the bearing surface is in each case equipped with a positioning device, so that a relative movement in all spatial directions becomes possible. The control of the two positioning devices is thereby preferably linked accordingly.

According to a further development, the measuring unit has a sensor assembly, comprising at least one first sensor for detecting the torque of the motor and at least one second sensor for detecting the normal force exerted via the measuring shaft and/or the first measuring head on the single sample. Data relating to the (shear) viscosity, elongational viscosity and shear stress of the sample are advantageously captured by means of the measurement of the torque of the motor because the torque correlates directly with the resistance of the sample against the rotational movement. The sensor for detecting the normal force, which is provided, for example, on the measuring shaft or on the measuring head, allows obtaining additional information about the load of the sample in the vertical direction, whereby the determination of viscoelastic properties is made both by storage module and loss module during the measuring process. The rheometer according to the invention thus provides for the capture of relative and absolute measuring variables in sequential – or, when arranging several measuring units, simultaneous – analysis of a plurality of samples. The sample throughput is thus increased significantly and the reproducibility of a comparative measurement of several identical samples is ensured.

According to a further embodiment, the at least one positioning device has a linear and/or a spindle drive. Linear or spindle drives or the combined use of these drives, respectively, advantageously allow for an exact control and capture of the path length and positioning of the measuring unit and of the bearing surface or of the sample carrier, respectively. This is advantageous for the precise path measurement because the drives provide for a uniform movement and the accuracy of the positioning in the entire system is thus improved. In particular spindle drives offer a high reproducibility because the positioning remains stable independently of load influences and the precise positioning of the respective elements to one another is thus ensured. The continuous and uniform movement of a spindle drive provides for the reliable integration into path measuring systems, such as, for example, linear potentiometers as well as optical or inductive measuring systems. The precise and continuous capture of the shifting position can thus be realized. For example, hydraulic drives or piezo motors either individually or in combination with the mentioned spindle and linear drives are also possible as alternative drives, which do not limit the invention.

According to a further embodiment of the rotational rheometer according to the invention, the bearing surface has a receptacle for the positionally fixed arrangement of the sample carrier. The accuracy in the pre-positioning of the sample carrier is advantageously increased hereby. The receptacle can be provided thereby on the bearing surface, for example in the form of positioning strips or points. It goes without saying that a receptacle, which is sunk into the bearing surface, is also possible, into which the respective sample carrier is inserted. The receptacle can be flexibly adapted to the size and base surface of the sample carrier, for example offset or shifted in the bearing surface. The user-friendliness is advantageously also increased by means of the receptacle because the positionally fixed receptacle provides for a quick and simple positioning of the sample carrier. This reduces the processing times during the loading of the rheometer because adjustments are unnecessary. In addition, the clearly defined positioning of the sample carrier in the receptacle is advantageous for automated measuring processes because the sample carrier is used in a standardized and fixedly specified position, which can also be stored in a control of the instrument and which can be assigned to different sample carriers.

According to a further embodiment of the rotational rheometer according to the invention, the sample carrier has a plurality of sample vessels, which are arranged in a defined pattern, for a respective one of the single samples. In this context, an advantageous further development provides that the sample carrier is formed as standardized microtiter plate with between 2 and 1536 sample vessels. In connection with the embodiments of the present invention, the sample carrier can also be formed as separate holder or as receptacle for microtiter plates. In particular, the size or base surface of the holder thereby essentially corresponds to the size or base surface of the microtiter plate. The simultaneous measurement of a plurality of samples is made possible with a high reproducibility in this way and the sample throughput is thus increased significantly. The sample preparation, which, due to the standard format of the sample carrier and the compatibility with common laboratory equipment and automated systems provided thereby, can thus also be performed in an automated manner and can be accelerated significantly, with corresponding advantages for the sample throughput. The standardized microtiter plate can additionally be inserted in the correspondingly adapted receptacle in the bearing plate and the system can thus be loaded quickly and easily with a plurality of samples. At the end of the analysis, the microtiter plate can be discarded or cleaned and reused, wherein the system is immediately available for the next measurement again. The arrangement of the sample vessels in a defined pattern also provides for a precise, automated alignment of the measuring unit relative to the samples. Due to the fact that microtiter plates are widely used in laboratories, they can be used with available handling systems, whereby the implementation of the rotational rheometer in existing operating processes is simplified, for example when placing the single samples. A further advantage of the use of microtiter plates lies in the flexibility of the system, which can process a small or very high number of samples, as needed.

According to a further development, the sample carrier has a coding, which identifies the single samples or the sample carrier, wherein a capturing unit for reading out the coding is additionally provided in the measuring unit and/or the bearing surface. Alternatively, a hand scanner can also be provided, which is used by the user when loading the instrument, in order to identify the sample vessel and to select the corresponding analysis protocol. The coding is advantageous in particular in the case of high throughput analyses and for the documentation of the measuring results. Due to the automatic or optionally manual capture of the coding, each sample carrier and/or each sample is identified uniquely, whereby an assignment of the measuring data to the single samples or sample carrier, respectively, is made possible. The improved documentation and traceability of the measurements is a further advantage of the coding. The automated capture of the sample identity ensures that the results are linked immediately to the corresponding samples, whereby a quick and error-free data capture and documentation is ensured. The coding furthermore simplifies the integration of the rotational rheometer in automated laboratory systems and allows for a seamless data capture in particular for quality control processes or in research projects.

According to a further embodiment, the bearing surface has a temperature control unit for the sample carrier and/or the sample vessels. This is particularly advantageous for the reproducibility and standardization of the test conditions. The possibility of precisely setting the temperature makes it possible to perform measurements under controlled conditions and improves the comparability of the results between different samples and measurements. Specific temperature requirements for each sample can be considered and the samples can in particular be protected against evaporation, in particular with the option of controlling the temperature of each individual sample vessel separately and individually. Temperature-related reactions of the samples can also be reduced or avoided, respectively, in response to contact with oxygen. This is particularly advantageous for samples, which are sensitive to temperature fluctuations, tend to evaporate or in the case of which certain thermal conditions (e.g., a temperature gradient across the sample carrier or the analysis) are significant for the analysis. A targeted temperature control additionally contributes to the conservation of the sample and prevents unwanted changes, which could be caused by temperature fluctuations. Different possibilities for forming the temperature control unit are available. These include, for example, and without limiting the invention thereto, Peltier elements, which provide a precise, quickly controllable cooling and heating function and which provide for a coordinated temperature control of individual sample vessels. It is furthermore possible to provide a water cooling or heating in the bearing surface. A homogenous temperature control of the sample carrier can also be achieved by means of regulated warm air or cold air flows, wherein a quick adaptation of the temperature is also possible hereby. The temperature control possibilities advantageously increase the flexibility and accuracy of the rotational rheometer because they precisely control the influence of the temperature on the rheological properties of the sample and create standardized thermal conditions.

According to a further development, a cleaning station, which is arranged in or on the bearing surface or which is assigned to the bearing surface, is provided for the measuring head. The measuring head can advantageously be cleaned by means of the cleaning station after each measurement or automatically, when necessary, in order to in particular avoid sample contaminations. The cleaning station thus ensures that no residues of the previous sample remain on the measuring head, whereby contaminations of the following samples are ruled out and consistent measuring conditions without distorting the measuring values are ensured.

According to a further embodiment, the measuring unit and the bearing surface are arranged in a housing. In particular a vibration dampening of the bearing surface and/or of the housing is provided thereby. Consistent environmental conditions, such as temperature, humidity and gas atmosphere (e.g., by means of inert gas filling of the housing, which is to preferably be closed in a gas-tight manner) are advantageously created hereby and the precision and reproducibility of the measurements is increased. The control of the environmental parameters minimizes external influences on the samples, in particular on samples with small volumes and low concentrations. The constant temperature in the housing ensures that thermal fluctuations do not influence the rheological properties of the sample. This offers advantages for the accuracy of the measurement of properties, such as viscosity, storage module and loss module. The regulation of the humidity prevents the drying out or the moisture absorption of the sample and prevents corresponding distortions of the measuring results. The possibility of creating a specific gas atmosphere, for example by means of an inert gas filling, protects sensitive samples against oxidation or other unwanted chemical reactions with components of the air. This is particularly relevant during the analysis of samples, which react to environmental conditions, such as, e.g., certain proteins or biomedical materials.

The vibration damping of the bearing surface and/or of the housing advantageously provides for a measurement with few interference variables, in particular of very small sample volumes (for example in the range of 10 µl) and with low concentrations of the relevant measuring material (e.g., protein quantities of 1 to 10 µg of protein per µl of sample volume).

According to a further embodiment, the rotational rheometer according to the invention further comprises a lighting unit, wherein the lighting unit is selected from: a UV light lighting unit, a lighting unit, which is designed to emit visible light, a lighting unit, which is designed to emit infrared light, a lighting unit, which is designed to emit polarized light, a lighting unit, which is designed to emit fluorescent light, in particular blue, green or red fluorescent light. With the possibility of using different types of light – such as UV light, visible light, infrared light, polarized light or fluorescent light – the application spectrum of the instrument is significant broadened in an advantageous manner. In an exemplary manner and not limiting the invention, the advantages of the different lighting types will be explained below. The use of UV light, photopolymerization or crosslinking reactions can be initiated in the sample and the examination of the rheological properties during such reactions can be performed in real time by means of a UV light lighting unit. A lighting unit for visible light provides for the direct monitoring of the sample during the measurement in order to recognize changes, such as phase transitions, sedimentation or aggregation. This can also be used in combination with optical sensors in order to capture additional data. An infrared light lighting unit can be used for the targeted heating of the sample in order to examine thermally induced rheological changes and provides for the performance of infrared spectroscopy for determining molecular structures and bonds during the rheological measurement. A lighting unit for polarized light supports the analysis of samples, which have different properties in different directions, such as, e.g., crystalline or fibrous materials, and provides for the observation of phenomena, such as double birefringence, which can point to changes in the molecular arrangement. A lighting unit for fluorescent light (blue, green or red) provides for the excitation of specific fluorophores in the sample and allows tracing dynamic processes, such as diffusion, conformational changes or binding events in real time. A targeted analysis of certain components can also be performed within complex samples by means of targeted marking of specific molecules in the sample.

According to a further development, an optical evaluation device, in particular a camera device, a microscope device or a fluorescence microscope is provided in the context in or on the bearing surface for optically evaluating the single samples. A simultaneous capture of rheological and optical data is made possible in an advantageous manner by means of the coupling with optical methods and the information content of the measurements is increased. The combination of rheological measurements with optical evaluation makes it possible to observe structural changes in the sample during the shear or deformation in real time. This improves the understanding of the connections between microscopic structures and macroscopic rheological properties. Phase separation, aggregation, gel formation, crystallization or morphology change in the sample can be observed directly with the help of microscopy or fluorescence microscopy. This proves to be advantageous in particular in material research and in the case of complex sample compositions. It is to be considered to be a further advantage that complex processes, such as protein aggregation, cell reactions, tissue or polymer alignment can be examined under mechanical load in particular in biomedical research, pharmaceutical development and polymer science.

According to a further development of the method, the rheological analysis of the single samples is performed on the basis of identical or single sample-specific analysis parameters. With the use of identical analysis parameters for all samples, it is ensured in an advantageous manner that the results are directly comparable with each other. This is particularly advantageous for examinations, during which deviations within a series are to be quantified and evaluated, such as, e.g., in quality control or in the case of batch analyses. Single sample-specific analysis parameters, in contract, allows for the adaptation of the measuring conditions to the individual properties of each sample in an advantageous manner, e.g., to the viscosity, concentration or temperature requirements. This is particularly advantageous in the case of heterogenous sample series, such as, for example, in biomedical research or material development. For samples with special requirements, such as, e.g., sensitive biological samples or highly viscous materials, the analysis can be optimized by means of specific settings (e.g., the shear rate or the temperature during the measurement). The measuring data can thus be adapted more precisely and better to the specific properties of each sample. With the possibility of measuring single samples with individual analysis parameters, materials with different rheological behavior types, for example, can be analyzed in a single cycle.

According to a further development of the method, it is further provided that the method comprises capturing optical analysis data of the single samples during the rheological analysis. This results in advantages with respect to the comprehensive characterization of the samples, the extension of the information content of the data and the real time observation of structural changes. The simultaneous capture of optical and rheological data advantageously provides for a deeper and more complete analysis of the sample. While the rheological data provides information about the mechanical properties (e.g., viscosity, elasticity), the optical data provides information about structural features and changes in the sample, such as particle size, aggregation or phase transitions. Dynamic changes inside the sample can additionally be monitored in real time by means of the optical capture during the rheological analysis. For example, phenomena, such as the formation of aggregates, gel formation, phase separation or the alignment of particles under shear load, can thus be observed and the relationship between structure and mechanical properties can be analyzed. As a whole, the further development of the method advantageously provides for an integrated and comprehensive analysis, which goes beyond the pure capture of rheological properties and which supports a detailed and structural characterization of the samples.

According to a further development of the method, the capture, evaluation and optionally graphic representation of the single sample-specific analysis data is provided in an evaluation and display unit. The evaluation and display unit advantageously provides for an immediate visualization of the analysis data for each single sample. The graphic representation of the data, e.g., in the form of curves or diagrams, makes it easier for the user to quickly interpret the results and to immediately recognize anomalies or trends in the data. Samples can also be compared to one another directly under identical or different analysis parameters by means of the uniform representation of the data in order to identify, for example, fluctuations or patterns within a sample series.

According to a further embodiment, the method further comprises the read-out of the coding assigned to the sample carrier and/or to the respective sample vessel and the setting of the analysis parameters based on the respective coding. The analysis parameters, which are specific for each sample, can advantageously be set without manual interventions by means of the automatic read-out of the coding. The automatic parameter adaptation saves time because the analysis parameters for each sample are set without manual interventions. This is particularly advantageous in the case of a large number of samples because the analysis process is accelerated significantly and the sample throughput is increased. If the coding contains specific parameters for each sample vessel, samples with different properties or requirements (e.g., viscosity, temperature, shear speed) can be analyzed in the same measuring cycle by means of sample-dependent change of the analysis parameters. Sample series with a variety of requirements and different measuring parameters in the single samples can thus advantageously also be processed efficiently. The direct take-over of the measuring or analysis parameters, respectively, from the coding eliminates the risk of input errors and provides for a completely automated and error-free adaptation of the analysis conditions. This is advantageous especially in the case of complex or variable protocols because human errors are ruled out. The coding also provides for the gap-free documentation of the analysis parameters for each sample. The automatic assignment and setting of the parameters simplifies the traceability of the measurements and simplifies the documentation. The automation, which can be reached via the coding, makes the method compatible with standardized and automated laboratory processes. The integration in existing systems and processes is simplified and the efficiency and scalability of the method is increased.

In a further development of the method according to the invention, it is provided that the cleaning of the measuring head is performed in a separate cleaning station, which is assigned to the bearing surface or which is arranged in the bearing surface, or in a cleaning vessel and a flush alignment of measuring head and cleaning station takes place prior to the cleaning by means of the positioning device. The separate cleaning station advantageously allows for a targeted and thorough cleaning of the measuring head under controlled conditions during the method. This reduces the risk that sample residues remain on the measuring head and are dragged into the following samples. The flush alignment of the measuring head to the cleaning station or a cleaning vessel by means of the positioning device automates the cleaning process and saves time because no manual intervention is required. The entire process can be integrated in an automated measuring process, whereby the efficiency is increased especially when analyzing many samples. The controlled cleaning in a separate vessel makes it possible to use different cleaning media or cleaning methods (e.g., rinsing liquids or ultrasound), which can be adapted to the respective sample. This is particularly advantageous when analyzing samples with highly varying properties, such as, e.g., viscous or slightly sticky materials.

In a further embodiment of the method according to the invention, it is provided that the cleaning of the measuring head is performed in at least one process vessel, which is provided in the sample carrier and which in particular contains a cleaning medium. Due to the fact that the cleaning vessel is integrated directly in the sample carrier, the necessity of controlling a separate cleaning station with a cleaning vessel is eliminated. This simplifies the process and provides for a quicker and more efficient performance of the intermediate cleaning steps. The elimination of the need for an external cleaning vessel advantageously also decreases the complexity of the instrument and saves space. This provides for a more compact construction and a simplified setup of the entire system. The use of a cleaning vessel, which is located in the sample carrier, simplifies the programming of automated measuring and cleaning processes. The measuring head can be guided directly to the cleaning vessel after an analysis, whereby a quick change between measuring and cleaning cycles becomes possible, without having to interrupt the work process. The cleaning vessel, which is located in the sample carrier, can be filled with different cleaning media as needed and thus allows for an optimal adaptation of the cleaning process to the respective sample series. This flexibility is advantageous especially in the case of samples with highly varying properties (e.g., viscos, sticky or solid substances). It is also possible to provide an intermediate step for drying the measuring head.

According to a further development of the sample carrier according to the invention, the sample carrier is formed as standardized microtiter plate with between 2 and 1536 sample vessels. In addition, the sample carrier can also be formed as holder or receptacle for microtiter plates, which can be inserted into the sample carrier, in the above-mentioned format. The size or base surface of the holder thereby essentially corresponds to the size or base surface of the microtiter plate. The microtiter plate advantageously provides for the analysis of a large number of samples in a single cycle and thus increases the sample throughput. The standardized construction of the microtiter plate additionally allows for the integration in automated laboratory systems and is compatible with common handling and analysis instruments. The variable number of sample vessels, which is possible due to the standardized microtiter plates, provides for the adaptation to different analysis requirements, from small to large sample series.

The above embodiments and further developments can be combined with one another arbitrarily, where useful. Further possible embodiments, further developments and implementations of the invention also comprise combinations, which are not mentioned explicitly, of features of the invention, which are described above or below with respect to the exemplary embodiments. The person of skill in the art will thereby in particular also add individual aspects to the respective basic form of the present invention as improvements or additions.

### BRIEF DESCRIPTION OF THE DRAWINGS

The present invention will be explained in more detail below on the basis of exemplary embodiments with reference to the enclosed figures of the drawings, in which:

FIG. 1a shows a schematic representation of a rotational rheometer according to an exemplary embodiment of the invention;

FIG. 2 shows a schematic representation of a sample carrier according to an exemplary embodiment of the invention in top view;

FIG. 3 shows a schematic representation of a sample carrier according to an exemplary embodiment of the invention in side view;

FIG. 4 shows a schematic representation of a bearing surface sample carrier in a rotational rheometer according to an exemplary embodiment of the invention in top view;

FIG. 5 shows a schematic representation of a rotational rheometer according to a further exemplary embodiment of the invention; and

FIG. 6 shows a flowchart of a method for sequentially analyzing single samples in a rotational rheometer according to an exemplary embodiment of the present invention.

### DETAILED DESCRIPTION

Unless otherwise specified, elements, features and components, which are identical, functionally identical and which have the same effect, are in each case provided with the same reference numerals in the figures of the drawing.

Even though specific embodiments and further developments are represented and described herein, the person of skill in the art will prefer that a plurality of alternative and/or similar embodiments can replace the represented and described specific exemplary embodiments, without turning away from the scope of the present invention. This application is to generally cover all modifications or changes to the specific exemplary embodiments described herein.

The enclosed figures are to provide a further understanding of embodiments of the invention and, in connection with the description, serve the purpose of explaining principles and concepts of the invention. Other exemplary embodiments and many of the mentioned advantages follow with regard to the drawings. The drawings are to only be understood as schematic drawings and the elements of the drawings are not necessarily represented true to scale to one another. Directional terminology, such as “top”, “bottom”, “left”, “right”, “above”, “below”, “horizontal”, “vertical”, “front”, “back” and similar information is used only for explanatory purposes and does not serve the purpose of limiting the generality to specific designs as shown in the figures.

Dashed lines in the figures of the drawings clarify that the connections between the components connecting the dashed lines do not mandatorily have to have physical contact to one another but can likewise be coupled wirelessly to one another.

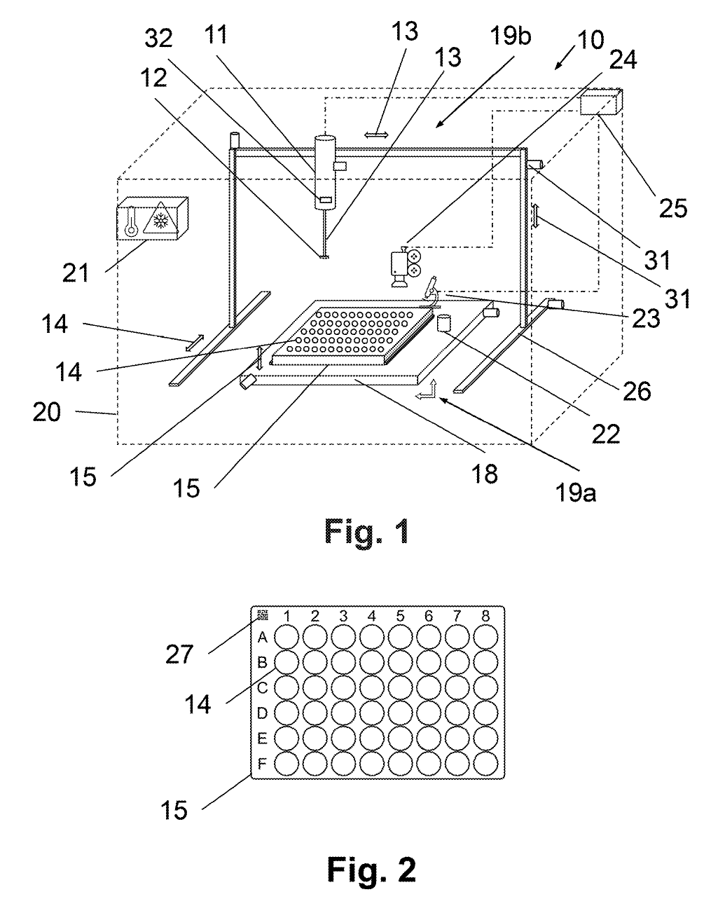

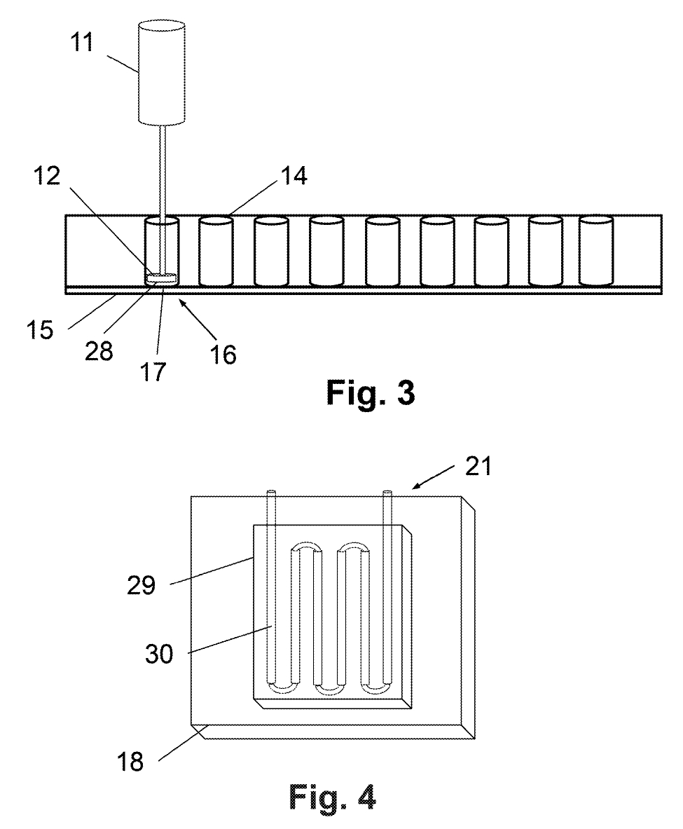

FIG. 1 shows a schematic representation of a rotational rheometer 10 according to an exemplary embodiment of the invention. The represented rotational rheometer 10 is designed to sequentially perform rheological analyses of single samples in one measuring cycle. The system has a measuring unit 11 with a measuring head 12, which is attached to a rotatable measuring shaft 13 and which can be lowered vertically into sample vessels 14 of a sample carrier 15 arranged below the measuring unit 11 in order to form a defined measuring gap 16 between the vessel bottom 17 (see FIG. 3) and the measuring head 12. The measuring unit 11 can be moved horizontally (arrow H1) along the width of the sample carrier 15 in order to control different sample vessels 14 in a row. This typically takes place by means of precise linear guides or linear or spindle drives 31. The horizontal movability in the depth of the sample carrier 15 (arrow T1) provides for the control of different rows of sample vessels 14. This movement takes place by means of additional linear or spindle drives 31. The vertical movement (arrow V1) serves the purpose of lowering the measuring head 12 into the respective sample vessel 14 or to lift it out of the latter. The z movement will can be realized by means of spindle drives, piezo motors or hydraulic drives, which ensure a high precision. The bearing surface 18, on which the sample carrier 15 is placed, can likewise be displaced in the x and y direction (arrows H2, T2) in order to align the respective sample vessel 14 relative to the measuring unit 11. The bearing plate can optionally be moved in the vertical direction (arrow V2), for example in order to adapt the height position of the sample carrier 15 relative to the measuring unit 11.

The measuring unit 11 additionally comprises different sensors, which are combined in a sensor assembly 32 and which are arranged so as to be distributed over the measuring unit 11, for measuring torque and normal force in order to determine rheological parameters, such as viscosity, shear stress and viscoelastic properties. The sample carrier 15 is arranged on a bearing surface 18 and comprises several sample vessels 14, which are aligned in a pattern. The positioning device 19a assigned to the bearing surface 18 provides for an alignment of the sample carrier 15 or of the individual sample vessels 14, respectively, relative to the measuring head 12. The bearing surface 18 as well as the measuring unit 11 are equipped with positioning devices 19a, b which allow for movements in the x, y and z direction, in order to perform the alignment and positioning of the measuring unit 11 and of the sample carrier 15 relative to one another. In the exemplary embodiment, the positioning device 19b of the measuring unit 11 is formed in the manner of a portal and has several horizontally and vertically aligned running rails 26, along which the measuring unit 11 is moved by means of linear or spindle drives 31 and is aligned relative to the sample carrier 15. The positioning device 19b of the measuring unit 11 can optionally also be configured for a pivoting or tilting of the measuring unit 11.

All elements of the rotational rheometer 10 are received in a housing 20, which can preferably be closed in a gas-tight manner. Said housing has a schematically represented temperature control unit 21, which controls and sets the environmental conditions (e.g., temperature, humidity and/or gas atmosphere) in the housing 20.

In the exemplary embodiment of FIG. 1, a cleaning station 22 for the measuring head 12 is furthermore integrated in the bearing surface 18. Said cleaning station is used in order to remove residues after each analysis and in order to avoid cross contaminations. The cleaning station 22 can optionally also be positioned in a stationary manner next to the bearing surface 18 or separately in the hosing 20.

In addition to the rheological measurement, an optical evaluation can take place, for example via a microscope device 23 or a camera 24, which documents structural changes to the sample during the analysis.

The rotational rheometer 10 also has an evaluation unit 25, which is connected in a wireless or wired manner to the individual elements (measuring unit 10, microscope device 23, camera 24), which records the rheological and optical data determined there and which processes said data for subsequent evaluations and/or a graphic representation.

FIG. 2 shows a schematic representation of a sample carrier 15 according to an exemplary embodiment of the invention in top view. The represented sample carrier 15 is formed in the form of a microtiter plate with sample vessels 14 arranged in a defined pattern. In the exemplary embodiment, the sample carrier comprises six rows (A to F) and eight columns (1 to 8), whereby a total of 48 sample vessels 14 are provided, but without limiting the invention thereto. Each sample vessel 14 is designed for receiving a single sample, so that a plurality of samples can be processed in a single analysis cycle. The sample carrier 15 is designed so that it can also have more or fewer sample vessels 14, depending on the requirement of the respective application. For example, sample carriers 15 with between 2 and 1536 sample vessels 14 can be used in order to adapt the sample throughput to the specific protocols. The sample carrier 15 can be embodied as standardized microtiter plate in order to ensure a compatibility with automated laboratory and handling instruments and standardized processes. The standardized pattern arrangement thereby simplifies the alignment of the sample carrier 15 relative to the measuring unit 11 and provides for an automated loading, positioning and analysis. The sample carrier 15 can additionally be provided with a coding 27, which can be read out automatically or manually (for example by means of a hand scanner), for example a QR code, which provides for the unique identification of the samples and the assignment of the respective measuring parameters and the documentation thereof.

FIG. 3 shows a schematic representation of a sample carrier 15 according to an exemplary embodiment of the invention in side view. FIG. 3 represents the sample carrier 15 with several sample vessels 14, which are held in a linear arrangement. A measuring head 12, which is part of the measuring unit 11, is sunk into one of the sample vessels 14 in order to perform the rheological measurement. In addition to the plate-shaped design illustrated here, the measuring head 12 can have further geometric configurations, which are known in connection with rheological measuring methods, and can be replaceably connected to the measuring unit 11. The measuring head 12 forms a defined measuring gap 16 between its underside 28 and the vessel bottom 17 of the sample vessel 14 in order to perform measurements of rheological parameters. The rheological measurements comprise typical variables, such as viscosity, shear stress, viscoelastic properties, storage module and loss module. The measurements and analysis parameters can be adapted individually for each single sample in the rotational rheometer 10 according to the invention in order to characterize, e.g., material behaviors under different shear conditions, temperatures or other external factors. Each sample can thus be analyzed under specific or standardized conditions in order to provide for comparable results as well as for a detailed characterization of single samples. The schematic representation furthermore shows that the sample carrier 15 is designed so that several samples can be analyzed one by one, wherein the measuring head 12 is moved from one sample vessel 14 to the next in an automated manner. This ensures a high sample throughput and reduces manual interventions during the analysis process.

FIG. 4 shows a schematic representation of a bearing surface 18 for a sample carrier 15 in a rotational rheometer 10 according to an exemplary embodiment of the invention in top view. The bearing surface 18 is equipped with a temperature control unit 21, which, in the exemplary embodiment, is embodied as flow-through cooler/heater with lines 30 running through the bearing surface or a receptacle 29 for the sample carrier 15, respectively, for a cooling/heating medium. The temperature control unit 21 serves the purpose of exactly setting and maintaining the temperature conditions during the rheological analysis, whereby a standardized and reproducible measuring environment is created. This is advantageous in particular in the case of sensitive samples or when examining temperature-sensitive properties of materials. Alternatively, the temperature control unit 21 can alternative or additionally have Peltier elements or warm air or cold air flow lines for controlling the temperature. The temperature control unit 21 can also be configured for the individual temperature control of individual sample vessels 14 and makes it possible to set specific temperatures or temperature profiles or gradients, respectively, for single samples, e.g., by means of integrated miniature hearing or cooling systems in the bearing surface.

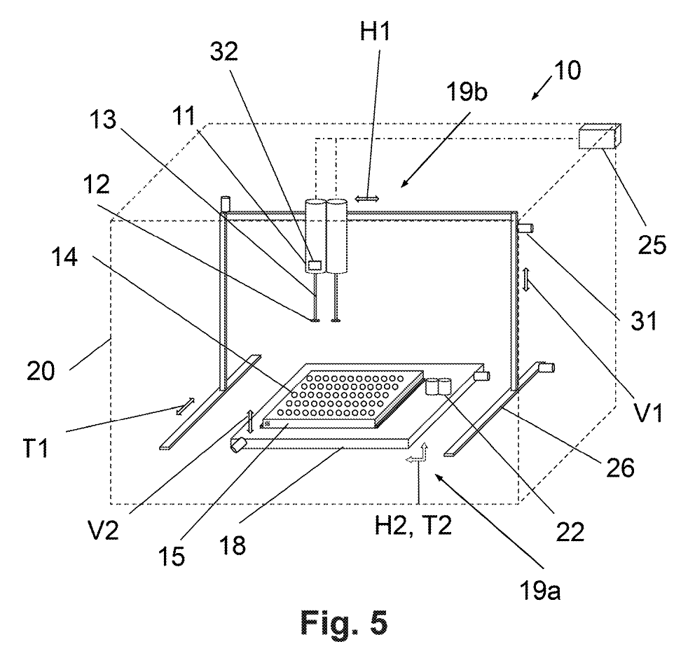

FIG. 5 shows a schematic representation of a rotational rheometer 10 according to a further exemplary embodiment of the invention, similarly to the rotational rheometer 10 as represented in FIG. 1. Identical elements are thus not described again. In contrast to the rotational rheometer 10 from FIG. 1, two measuring units 11 are provided in the exemplary embodiment of FIG. 5, which provide for a simultaneous measurement of samples in different sample vessels 14. Each measuring unit 11 can be positioned independently, wherein a precise control of the respective sample vessels 14 for both measuring units takes place prior to the simultaneous measurement. As in the embodiment according to FIG. 1, the measuring units 11 can be moved horizontally (arrow H1) along the width of the sample carrier 15 in order to control different sample vessels 14 in one row. This typically takes place by means of precise linear guides or linear or spindle drives 31. The horizontal movability in the depth of the sample carrier 15 (arrow T1) provides for the control of different rows of sample vessels 14. This movement takes place by means of additional linear or spindle drives 31. The vertical movement (arrow V1) serves the purpose of lowering the measuring heads 12 into the sample vessels 14 or to lift them out of them. The z movement can be realized by means of spindle drives, piezo motors or hydraulic drives, which ensure a high precision. The bearing surface 18, onto which the sample carrier 15 is placed, can likewise be displaced in the x and y direction (arrows H2, T2) in order to align the sample vessels 14 relative to the measuring units 11. The bearing plate can optionally be moved in the vertical direction (arrow V2), for example to adapt the height position of the sample carrier 15 relative to the measuring units 11. In addition to the stationary embodiments represented in FIGS. 1 and 5, a portable setup, for example with compressed gas cylinders for supplying a correspondingly gas-pressurized air bearing of the measuring unit 11 and photovoltaic cells for the power supply, is also possible, wherein the rotational rheometer according to the invention is then also suitable for the use in regions or environments without sufficient infrastructure.

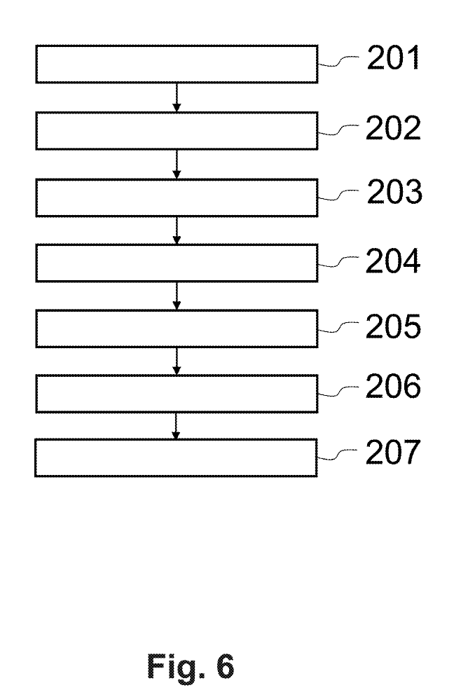

FIG. 6 shows a flowchart of a method for sequentially analyzing single samples in a rotational rheometer 10 according to an exemplary embodiment of the present invention. In a first method step 201, single samples are placed in an automated or manual manner in the sample vessels 14 of a sample carrier 15. In the next step 202, the arranging of the sample carrier 15 comprising several sample vessels 14 with the single samples placed in the sample vessels 14 takes place on or in a bearing surface 18 of the rotational rheometer 10. At the start of the measuring process, the measuring head 12 of the measuring unit 11 and a first sample vessel 14 are aligned in a flush manner relative to one another in step 203. This takes place by moving the measuring unit 11 and/or the bearing surface 18 via the drives assigned to both elements. In a step 204 following the aligning, the measuring head 12 is sunk into the sample vessel 14. The sink-in depth is defined in the analysis protocol in coordination with the geometry of the sample vessel 14 in such a way that the measuring head 12 is lowered so far that a measuring gap 16 forms between the measuring head 12 and a vessel bottom 17 of the sample vessel 14. After completing the measuring preparations, a rheological analysis is performed in step 205 in the respective sample vessel 14 and rheological analysis data of each single sample is captured by means of sensors of a sensor assembly 32 assigned to the measuring unit 11. In step 206, the measuring head 12 is lifted out of the sample vessel 14 after conclusion of the analysis. In a further step 207, the measuring head 12 is cleaned in a controllable cleaning station 22 or by sinking into a sample vessel 14 of the sample carrier 15, which is filled with a cleaning liquid, and is prepared for the next analysis. In the latter case, only half of the sample vessels 14 is loaded with samples and the remaining sample vessels 14 contain the respective, optionally sample-specific, cleaning liquid. A drying step can optionally be connected downstream. The above-mentioned steps are repeated until the measuring protocol has been processed and all samples have been analyzed in the sample carrier 15.

Different features have been combined in the preceding detailed description in one or several examples in order to improve the stringency of the representation. It should be clear thereby, however, that the above description is only of an illustrative, but in no way of a limiting nature. It serves the purpose of covering all alternatives, modifications and equivalents of the different features and exemplary embodiments. Many other examples will be immediately and directly clear to the person of skill in the art based on his expert knowledge in consideration of the above description.

The exemplary embodiments have been selected and described in order to be able to present the principles, on which the invention is based, and the application possibilities thereof in practice in the best possible way. Experts can thus optimally modify and use the invention and its different exemplary embodiments with regard to the intended use. The terms “including” and “having” in the claims as well as the description are used as neutral terminologies for the corresponding terms “comprising”. A use of the terms “a” and “an” is to furthermore not generally rule out a plurality of such described features and components.

1. A rotational rheometer for sequentially analyzing single samples in sample vessels of at least one sample carrier, which in each case has several sample vessels, comprising:
at least one measuring unit with a measuring head, which can be arranged on a rotatable measuring shaft and which can be sunk into the respective sample vessel, in order to form a measuring gap in the region of a sample bottom of the sample vessel; and
a bearing surface for the sample carrier, which is spaced apart relative to the measuring unit,
wherein at least one positioning device is provided for the flush alignment of the measuring head and of the respective sample vessel prior to the analysis of the single sample.

2. The rotation rheometer according to claim 1, wherein at least one positioning device is provided in the bearing surface, wherein the positioning device is configured for positioning the sample carrier in the horizontal and vertical direction relative to the measuring head.

3. The rotational rheometer according to claim 1, wherein at least one positioning device assigned to the measuring unit for positioning the measuring head at least in the horizontal and vertical direction relative to the sample carrier is provided.

4. The rotational rheometer according to claim 1, wherein the measuring unit has a sensor assembly, comprising at least one first sensor for detecting the torque of the motor and at least one second sensor for detecting the normal force exerted via the measuring shaft and/or the first measuring head on the single sample.

5. The rotational rheometer according to claim 1, wherein the at least one positioning device has a linear and/or a spindle drive.

6. The rotational rheometer according to claim 1, wherein the bearing surface has a receptacle for the positionally fixed arrangement of the sample carrier.

7. The rotational rheometer according to claim 1, wherein the sample carrier has a plurality of sample vessels, which are arranged in a defined pattern, for a respective one of the single samples.

8. The rotational rheometer according to claim 7, wherein there sample carrier is formed as standardized microtiter plate with between 2 and 1536 sample vessels or holder for a standardized microtiter plate with between 2 and 1536 sample vessels.

9. The rotational rheometer according to claim 1, wherein the sample carrier has a coding, which identifies the sample carrier and/or the single samples and a capturing unit for reading out the coding is provided in the measuring unit and/or the bearing surface.

10. The rotational rheometer according to claim 1, wherein the bearing surface has a temperature control unit for the sample carrier and/or the sample vessels.

11. The rotational rheometer according to claim 1, wherein a cleaning station, which is arranged in or on the bearing surface or which is assigned to the bearing surface, is provided for the measuring head.

12. The rotational rheometer according to claim 1, wherein the measuring unit and the bearing surface are arranged in a housing and in particular a vibration damping of the bearing surface and/or of the housing is provided.

13. The rotational rheometer according to claim 1, further comprising a lighting unit, wherein the lighting unit is selected from: a UV light lighting unit, a lighting unit, which is designed to emit visible light, a lighting unit, which is designed to emit infrared light, a lighting unit, which is designed to emit polarized light, a lighting unit, which is designed to emit fluorescent light, in particular blue, green or red fluorescent light.

14. The rotational rheometer according to claim 1, wherein an optical capturing device, in particular a camera, a microscope device or a fluorescence microscope is provided in or on the bearing surface for optically capturing the single samples.

15. A method for sequentially analyzing single samples in a rotational rheometer, in particular in a rotational rheometer for sequentially analyzing single samples in sample vessels of at least one sample carrier, which in each case has several sample vessels, including:
at least one measuring unit with a measuring head, which can be arranged on a rotatable measuring shaft and which can be sunk into the respective sample vessel, in order to form a measuring gap in the region of a sample bottom of the sample vessel; and
a bearing surface for the sample carrier, which is spaced apart relative to the measuring unit,
wherein at least one positioning device is provided for the flush alignment of the measuring head and of the respective sample vessel prior to the analysis of the single sample wherein the method comprises to steps of:
arranging a sample carrier having several sample vessels with single samples placed in the sample vessels on or in a bearing surface;
flush alignment of the measuring head of the measuring unit of the rotational rheometer relative to a first one of the respective sample vessels by means of the positioning device;
sinking the measuring head into the sample vessel in order to form a measuring gap between the measuring head and a vessel bottom of the sample vessel;
performing the rheological analysis in the respective sample vessel and capturing rheological analysis data of each single sample by means of the sensor assembly;
lifting the measuring head out of the sample vessel after conclusion of the analysis;
cleaning or replacing the measuring head or elements of the measuring head contacted by the sample; and
repeating the preceding steps until the conclusion of the analysis of all single samples of the sample carrier.

16. The method according to claim 15, wherein the rheological analysis of the single samples is performed on the basis of identical or single sample-specific analysis parameters.

17. The method according to claim 15, further comprising: capturing optical analysis data of the single samples during the rheological analysis.

18. The method according to claim 15, further comprising: capturing, evaluating and optionally graphically representing the single sample-specific analysis data in an evaluation and display unit.

19. The method according to claim 15, further comprising: reading out the coding assigned to the sample carrier and/or the respective sample vessel and setting the analysis parameters on the basis of the respective coding.

20. The method according to claim 15, wherein the cleaning of the measuring head is performed in a separate cleaning station, which is assigned to the bearing surface or which is arranged in the bearing surface, and a flush alignment of measuring head and cleaning station takes place prior to the cleaning by means of the positioning device.

21. The method according to claim 15, wherein the cleaning of the measuring head is performed in at least one sample vessel, which is provided in the sample carrier and which in particular contains a cleaning medium.

22. A sample carrier, in particular for use in a rotational rheometer for sequentially analyzing single samples in sample vessels of at least one sample carrier, which in each case has several sample vessels, comprising:
at least one measuring unit with a measuring head, which can be arranged on a rotatable measuring shaft and which can be sunk into the respective sample vessel, in order to form a measuring gap in the region of a sample bottom of the sample vessel; and
a bearing surface for the sample carrier, which is spaced apart relative to the measuring unit,
wherein at least one positioning device is provided for the flush alignment of the measuring head and of the respective sample vessel prior to the analysis of the single sample,
wherein the sample carrier has a plurality of sample vessels, which are arranged in a defined pattern, for a respective single sample

23. The sample carrier according to claim 22, wherein the sample carrier is formed as standardized microtiter plate with between 2 and 1536 sample vessels or as holder for a standardized microtiter plate with between 2 and 1536 sample vessels.

24. A use of a sample carrier wherein the sample carrier is formed as standardized microtiter plate with between 2 and 1536 sample vessels or as holder for a standardized microtiter plate with between 2 and 1536 sample vessels sequentially rheologically analyzing single samples in a rotational rheometer, [[in particular in a rotational rheometer comprising:
at least one measuring unit with a measuring head, which can be arranged on a rotatable measuring shaft and which can be sunk into the respective samplevessel, in order to form a measuring gap in the region of a sample bottom of the sample vessel; and
a bearing surface for the sample carrier, which is spaced apart relative to the measuring unit,
wherein at least one positioning device is provided for the flush alignment of the measuring head and of the respective sample vessel prior to the analysis of the single sample.
